(19) United States
(12) Patent Application Publication
(10) Pub. No.: US 2012/0292259 A1
(43) Pub. Date: Nov. 22, 2012

(54) SYSTEM AND METHOD FOR TREATMENT OF PRODUCED WATERS CONTAINING GEL

(75) Inventor: Mark A. Marcin, Pine, CO (US)

(73) Assignee: High Sierra Energy, LP, Denver, CO (US)

(21) Appl. No.: 13/473,077

(22) Filed: May 16, 2012

Related U.S. Application Data
(60) Provisional application No. 61/486,982, filed on May 17, 2011.

(51) Int. Cl. C02F 9/04; C02F 101/30; C02F 101/32

(52) U.S. Cl. 210/721; 210/190; 210/702

(57) ABSTRACT

This disclosure describes novel systems and methods for removing gel from flowback water. The methods and systems include treating acidified flowback water with aluminum chlorohydrate.

### RELATED APPLICATIONS

This application claims the benefit of U.S. Provisional Application No. 61/486,982, filed May 17, 2011, and entitled “System and Method for Treatment of Produced Waters Containing Gels” which application is hereby incorporated herein by reference.

### INTRODUCTION

The drilling of natural gas and oil wells continues to expand throughout the United States. The success of these activities is directly related to the use of recently developed hydrofracturing techniques. While these techniques continue to evolve and change, the one constant is the need for large quantities of water.

Typically, oil and gas exploration and production results in the extraction of a significant amount of subsurface water, called produced water, along with the hydrocarbon. If hydrofracturing is being used in the area, much of the water used in hydrofracturing may also flowback to the surface. Because produced water containing spent hydrofracturing water contains the man-made additives injected as part of the hydrofracturing process in addition to the normal contaminants associated with produced water, it is usually referred to as “frac flowback water” or “flowback water” to indicate the different chemistry.

Without expensive treatment, flowback water is not typically suitable for direct reuse in the hydrofracturing (or “frac”) process due to a portion of the flowback which contains man-made or natural additives used to improve the frac process (generally referred to as “frac gel” or, simply, “gel” in the industry). This gel, which served as a viscosity modifier during the frac process, interferes with most chemical and physical treatment methods. A gel often includes large chain, high molecular weight, polymers such as guar gum. When present in flowback water, gel increases the chemical and biological oxygen demand (COD and BOD) of that water and encourage the growth of bacteria. The bacteria growth is not desirable from a reuse aspect. In addition, spent gel often interferes with the operation of fresh gel, rendering reuse of the flowback water undesirable as a feed water for the frac process.

The most logical means by which to minimize fresh water usage in hydrofracturing is to recycle flowback and produced water into future hydrofracturing activities. The reuse of this water is only limited by the contamination from the hydrofracturing additives and mineral deposits far beneath the earth's surface. This contamination exists in the form of, but not limited to, suspended solids and scale forming compounds such as iron, calcium, magnesium, barium and strontium. To utilize these contaminated waters in hydrofracturing without proper treatment places the long term performance of the well at risk and may increase capital spending due to unnecessary and avoidable well reworking.

### TREATMENT OF PRODUCED WATERS CONTAINING GEL

This disclosure describes novel systems and methods for removing gel from flowback water. The methods and systems include treating acidified flowback water with aluminum chlorohydrate.

In part, this disclosure describes a method for removing gel from flowback water. The method includes:

a) adjusting a pH of flowback water to about 5 or less to form acidified water;

b) adding aluminum chlorohydrate to the acidified water causing a gel to precipitate out of the acidified water; and

c) separating the gel from the acidified water to form gel treated flowback water.

Yet another aspect of this disclosure describes a water treatment system that includes an oil removing system, a gel removing system, and a water softening system. The oil removing system adds acid until a pH of about 5 or less is reached and removes oil from gel containing flowback water to form oil treated acidified flowback water. The gel removing system adds aluminum chlorohydrate to the oil treated acidified flowback water to form gel treated flowback water. The water softening system softens the gel treated flowback water to form softened treated flowback water.

These and various other features as well as advantages which characterize the systems and methods described herein will be apparent from a reading of the following detailed description and a review of the associated drawings. Additional features are set forth in the description which follows, and in part will be apparent from the description, or may be learned by practice of the technology. The benefits and features of the technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of embodiments of systems and methods described below and are not meant to limit the scope of the invention in any manner, which scope shall be based on the claims.

FIG. 1 illustrates an embodiment of a water treatment system for treating contaminated water according to the principles of the present disclosure.

FIG. 2 illustrates an embodiment of an oil removal system for removing oil from contaminated water according to the principles of the present disclosure.

FIG. 3 illustrates an embodiment of a gel removal system for removing gel from contaminated water according to the principles of the present disclosure.

FIG. 4 illustrates an embodiment of a water softening system for softening contaminated water according to the principles of the present disclosure.

FIG. 5 illustrates an embodiment of a method for treating contaminated water according to the principles of the present disclosure.

### DETAILED DESCRIPTION

Unless otherwise indicated, all numbers expressing quantities of ingredients, properties such as molecular weight, concentrations, reaction conditions, temperatures, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained. At the very least, and not as an attempt to limit the application of the doctrine of equivalents to the scope of the claims, each numerical parameter should at least be construed in the light of the number of reported significant digits and by applying ordinary rounding techniques.

The term “floating” as used herein refer to treating a liquid with a flotation operation to separate solid or liquid particles from a liquid phase. There are several types of flotation operations that are well known in the art including dissolved-air flotation (DAF), air flotation and vacuum flotation.

When referring to concentrations of contaminants in water or to water properties such as pH and viscosity, unless otherwise stated the concentration refers to the concentration of a sample properly taken and analyzed according to standard Environmental Protection Agency (EPA) procedures using the appropriate standard test method or, where no approved method is available, commonly accepted methods may be used. For example, for Oil and Grease the test method identified as 1664A is an approved method. In the event two or more accepted methods provide results that indicate two different conditions as described herein, the condition should be considered to have been met (e.g., a condition that must be “above pH of about 7.0” and one accepted method results a pH of 6.5 and another in pH of 7.2, the water should be considered to be within the definition of “about 7.0”).

Water use in hydrofracturing varies from basin to basin and even within the basin. For example, in some areas of the Piceance Basin in western Colorado the amount of water utilized is 60,000 barrels (2,520,000 gallons) per well while in some areas of the Marcellus play in Pennsylvania and surrounding states, hydrofracturing requires up to 150,000 barrels (6,300,000 gallons) per well. With thousands of wells being drilled in these and other basins every year, the demand on naturally occurring surface water sources as well as sub-surface aquifers is significant.

In areas of the arid West, water resources are limited and are a valuable commodity. In areas which may traditionally have been considered water rich, such as the Marcellus, there are growing concerns over fresh water use for hydrofracturing. These concerns could lead to restrictions on drilling activity, as has already happened in the State of New York. Considering that the development of our own natural resources decreases our dependency on foreign oil, improvements to minimize fresh water use must be achieved in order to avoid further restrictions on drilling activity.

The contamination of the fresh water during the hydrofracturing processes also varies from basin to basin and even within individual basins. In western Colorado, calcium levels may range from 250 to 500 mg/l while in areas of the Marcellus, calcium may range between 1000 and 20,000 mg/l. Scaling components such as barium may see an even wider range, with levels in Colorado ranging from 12 to 50 mg/l compared to 100 to 3000 mg/l in the Marcellus.

As discussed above, without expensive treatment, flowback water is not typically suitable for direct reuse in the hydrofracturing process due to a portion of the flowback water which contains frac gel. This gel interferes with most chemical and physical treatment methods. A gel often includes large chain, high molecular weight, polymers such as guar. Further, a gel may increase bacteria growth in the flowback water, which is not desirable from a reuse aspect. In addition, spent gel often interferes with the operation of fresh gel, rendering reuse of the flowback water undesirable as a feed water for the frac process.

Technologies such as electrocoagulation (EC) have proved to be ineffective in the removal of gel. Gel in flowback water will typically cause the failure of mechanical filtration processes as well as gravity clarification processes. Treatment processes such as chemical oxidation break the polymer chains into shorter, lower molecular weight chains. However, the conversion to carbon dioxide and water by chemical oxidation is difficult, and requires long contact times and excessive amounts of oxidants. Therefore, an effective treatment process must be developed to deal with this component of flowback water.

The methods and systems described herein presents a process for the treatment of these varying hydrofracture flowback waters to remove undesirable constituents allowing the water to again be used in new well development and hydrofracturing procedures. More specifically, the systems and methods described herein relate to the removal of gel, such as guar gum or, simply, “guar”, from the hydrofracture flowback waters. The methods and systems can be conducted onsite as well as in fixed facilities. Onsite treatment greatly reduces the environmental impacts that trucking large volumes of water presents.

The removal of the gel from flowback water is the critical step before other downstream treatment technologies can be applied. The gel, such as guar, is removed through a unique chemical process that alters the solubility of the gel in the flowback water and allows for the physical separation of the gel from the remaining wastewater. This is different than other approaches to treatment that require chemical or biological oxidation and the breaking of the gel polymer chains into smaller molecular weight segments. In the systems and methods described herein, the gel is removed from the flowback water, immediately decreasing the chemical and biological oxygen demand (COD and BOD), which reduces downstream loading to other technologies. This gel removal step allows the remaining flowback water to be treated with typical wastewater treatment technologies or blended with produced waters and treated with repeatable results.

The entire process is capable of achieving very low levels of the scale forming chemical compounds mentioned above. For example, the process described herein can treat barium and strontium to less than 1 mg/l and calcium to less than 100 mg/l. The process goals will vary from well site to well site, with disposal being the economic alternative to recycling this water. For example, disposal of flowback and produced water in some areas of the country can be accomplished for less than $0.25/barrel while, in other areas, costs may exceed $14.00/barrel. The degree of constituent removal is directly related to the amount of chemistry feed which, in turn, plays a primary role in determining the overall cost of treatment. The operator of the oil or gas drilling program will then have to balance disposal costs with treatment costs to determine the level of treatment necessary to achieve performance goals.

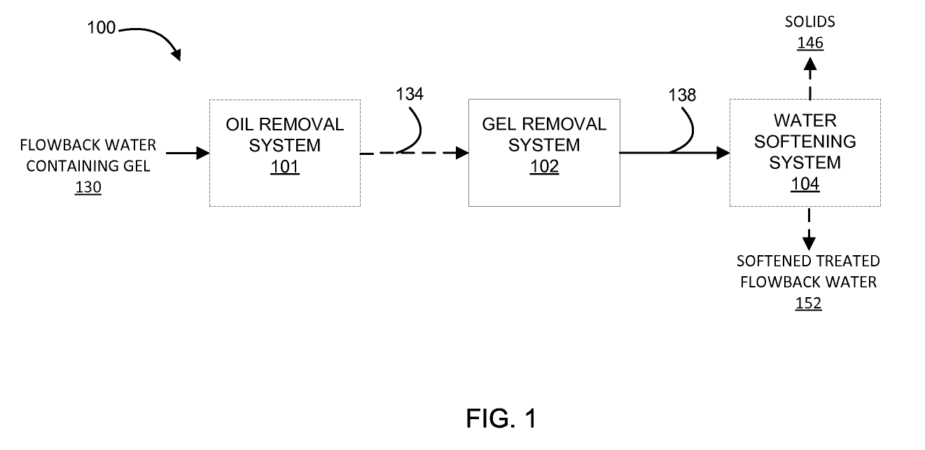

FIG. 1 illustrates an embodiment of a water treatment system 100 for treating contaminated water. The water treatment system 100 for treating contaminated water includes a gel removal system 102. In some embodiments the water treatment system 100 further includes an oil removal system 101 and/or a water softening system 104.

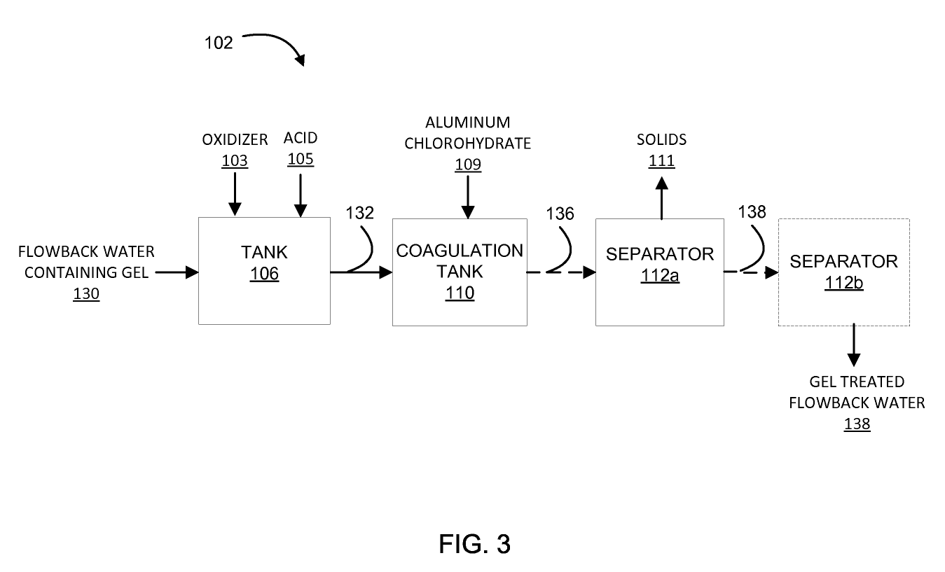

FIG. 3 illustrates an embodiment of a gel removal system 102. The gel removal system 102 includes a tank 106, a coagulation tank 110, and at least one solid liquid separator 112. Flowback water containing gel 130 is pumped into tank 106. In some embodiments, the flowback water containing gel 130 is pumped by others from storage pits or tanks into tank 106. The tank 106 may be any suitable tank 106, such as a surge tank 106 or mixing tank 106, for holding and mixing the flowback water containing gel 130 with acid 105.

The flowback water containing gel 130 is returning from hydrofracture operations and contains various undesirable constituents such as gel, iron, barium, calcium, magnesium and strontium. Often, prior to treatment, the flow back water is stored in pits or tanks. Ideally, flowback water containing gel 130 should be isolated and treated separately by the system 100 or the gel removal system 102 thereby minimizing the space and costs associated with the additional treatment technology needed to treat flowback water containing gel 130. Once treated through system 100, the water can then be comingled with flowback water that does not contain gel and produced water. If such segregation is not feasible, all water may be treated with this process.

A utilized surge tank 106 provides equalization of flow. The flow rate is highly flexible and determines the size of the mixing tanks. Typically, flow rates between 30 gpm to 1000 gpm are possible; however, the gel removal system 102 may be designed to accommodate any range of flow rates. In some embodiments, the surge tank 106 is aerated using a centrifugal blower.

The acid 105 is added to tank 106 and mixed, if possible, with the flowback water containing gel 130 to form acidified water 132. The acid 105 is added to depress the pH to 5 or less. In some embodiments, the acid 105 is added until the pH is about 4-5. In other embodiments, the acid 105 is added until the pH is about 4.5 to 5. In yet another embodiment, the pH is adjusted until the pH is about 5.5 or less. In further embodiments, the acid 105 is hydrochloric acid. In other embodiments, the acid 105 is sulfuric acid or some other acid, possibly selected based on the salt that will result in the treated water. The addition of acid 105 effectively removes soluble carbon dioxide and bicarbonates through conversion to carbon dioxide gas which is stripped through the action of mixing. In some embodiments, the escaping carbon dioxide gas from the surge tank 106 is captured for use later. In some embodiments, the addition of acid 105 is controlled automatically using a pH controller and pH probe immersed in the surge tank 106. For example, the addition of acid 105 may result in the following equation:

HCO₃+HCl [symbol] CO [symbol] +H₂O+Cl.

Other options for those skilled in the trade for air stripping carbon dioxide would be packed columns, tray towers, spray systems and membranes systems. Further, membrane systems may be prone to malfunction due to the gel contained in some flowback water. These systems could follow the surge tank 106 and would allow the minimization of surge tank 106 volume to a volume large enough to accomplish pH adjustment efficiently.

In some embodiments, one or more oxidizers 103, such as hydrogen peroxide, ozone, sodium hypochlorite, persulfates, chlorine dioxide and sodium or potassium permanganates as well as any other chemical oxidizer, are added for bacterial control as well as the conversion of ferrous iron species into the more insoluble ferric iron species. The removal of other species such as manganese will also benefit from this approach as would the destruction of sulfide species.

Contact time between the acid 105 and the flowback water containing gel 130 in the surge tank 106 may be maintained at a minimum of 30 minutes or some other period of time to provide adequate time to strip the carbon dioxide gas from solution. Alternatively, the tank 106 could be monitored so that the contact time could be varied to achieve some set treatment target, such as a dissolved carbon dioxide level. In some embodiments, 90% of the carbon dioxide is removed using this approach. If higher removals are desired, the aforementioned packed towers and membranes systems maybe employed.

As discussed above, the addition of acid 105 reduces the pH of the flowback water to 5 or less resulting in acidified water 132. A pH of 5 or less is additionally beneficial for several other processes such as destabilizing weak oil in water emulsions.

The acidified water 132 is pumped into the coagulation tank 110. Aluminum chlorohydrate is added to the acidified water 132 in the coagulation tank 110 at a rate determined by applicable jar tests or by active monitoring. This addition causes an immediate and rapid separation of the gel. The reaction can be followed visually and the newly formed gel is insoluble in the flowback fluid forming flowback fluid with insoluble gel 136. In addition, the gel, with a specific gravity lower than water floats to the surface at a rapid rate. The flowback fluid containing gel must remain at a pH of 5 or less as any attempt to raise the pH of the fluid containing the gel allows it to resolubilize. Accordingly, separation of the insoluble gel must be accomplished under acidic conditions. Previously utilized gel separation methods were always performed at or around a neutral pH. Accordingly, it was unexpected for the aluminum chlorohydrate to work utilizing an acidic pH.

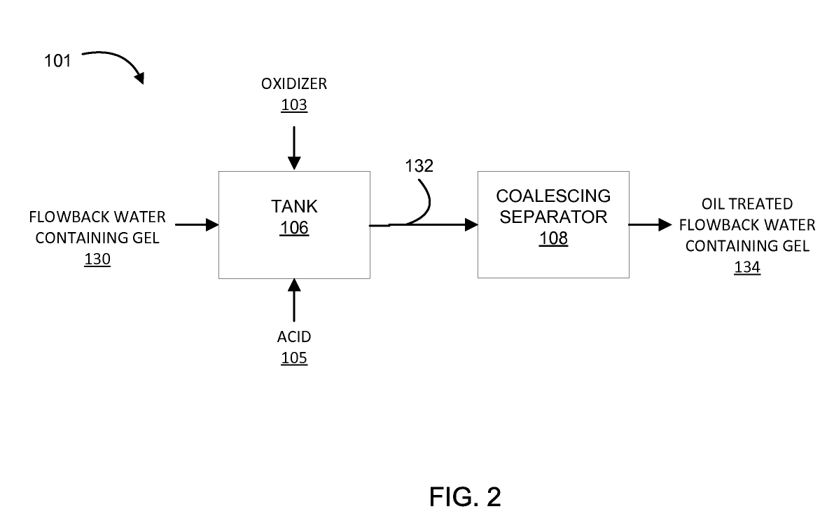

FIG. 2 illustrates an embodiment of an oil removal system 101. In some embodiments, oil is removed from the acidified water 132 by the oil removal system 101 prior to being pumped into the coagulation tank 110. The oil removal system 101 may be performed by any components for removing oil from flowback water containing gel 130 now known or later developed, such as an American Petroleum Institute (API) oil-water separator. For example, the oil removal system 101 may include a coalescing separator 108. The coalescing separator 108 receives the acidified water 132 from the surge tank 106. In some embodiments the acidified water 132 is pumped into the coalescing separator 108 using a non-emulsifying mechanical pump. The coalescing separator 108 separates oil from the flowback water and is recovered for resale. The process may utilize a unique oil/water separator 108 which combines the solids handling capability of an inclined plate separator along with the coalescing ability of a media with a high surface area, such as HD Q-PAC. Such a separator 108 is available from Hydro Quip Inc., located at 108 Pond Street, Seekonk, Mass. 02771. In some embodiments, the oil removal system 101 results in recovery of at least 50% and up to 99% of oil droplets greater than 20 microns to form oil treated flowback water containing gel 134. The term “oil treated flowback water” as used herein refers to flowback water that has had a significant portion of its oil droplets greater than 20 microns removed, such as 30% or more. In some embodiments, the oil removal system 101 results in recovery of at least 85% of oil droplets greater than 20 microns to form oil treated flowback water containing gel 134. Accordingly, in some embodiments, the acidified water 132 sent to the coagulation tank 110 of the gel removal system 102 is the oil treated flowback water containing gel 134.

The formed flowback fluid containing an insoluble gel 136 is then sent to a solid liquid separator or clarifier 112 as illustrated in FIG. 2. The flowback fluid containing insoluble gel 136 flows into a solid liquid separation phase. To take advantage of the buoyant characteristics of the insoluble gel, in some embodiments, the solid liquid separator 112 is a dissolved air floatation (DAF), an induced air floatation or a dissolved gas floatation. The insoluble gel accumulates on the surface of the flotation area of the clarifier or separator 112 and is removed by the clarifier's sludge removal mechanism resulting in gel treated flowback water. The term “gel treated flowback water” as used herein refers to the effluent that results from treating or processing gel containing flowback water with the gel removal system 102. The solids produced from the gel 111 are rubber-like in consistency and dewater readily. The solids 111 can be dewatered through any means conventionally used by those skilled in the art.

In some embodiments the gel removal system 102 includes a first separator 112a and second separator 112b. The discharge of the second clarifier or separator 112b results in a low turbidity, low total suspended solids effluent (i.e. flowback fluid containing little to no gel 138). The primary remaining constituents of concern are now scale forming ions as described earlier in this review.

The flowback fluid containing little to no gel or gel treated flowback water 138 may be given for additional treatment through a variety of steps. For example, in some embodiments, the flowback fluid containing little to no soluble gel is passed through a second coagulation tank and a flocculation tank at a pH more conducive to flocculation (6.5-8.0). In some embodiments, due to the nature of the flowback fluid, the separation equipment may be floatation clarifiers.

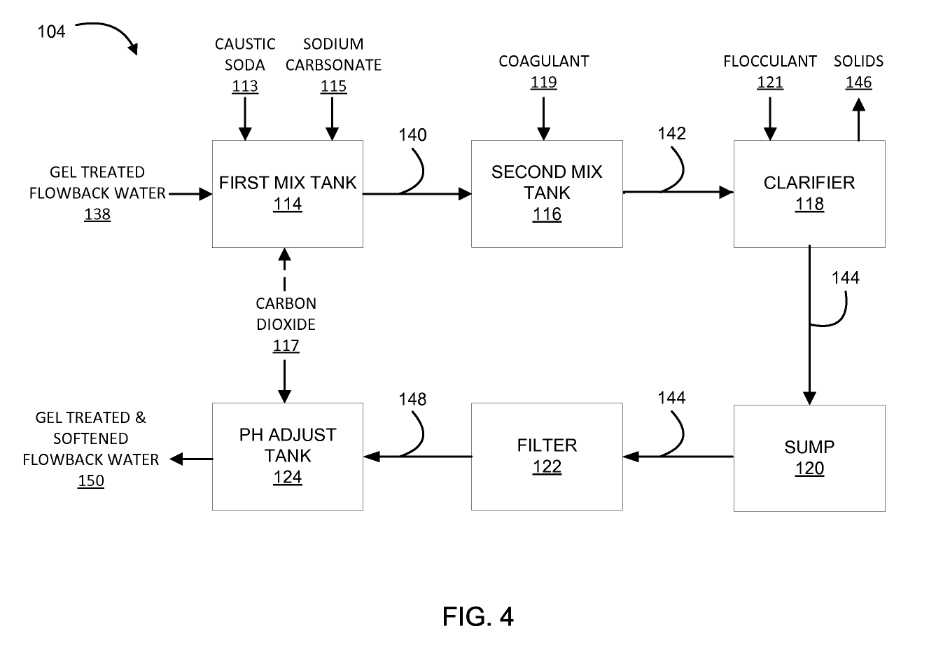

FIG. 4 illustrates an embodiment of a water softening system 104. In some embodiments, the flowback fluid containing little to no gel or gel treated flowback water 138 is then sent to a water softening system 104. The water softening system 104 may be performed by any components for softening water, such as chemical softening water. In some embodiments, the water softening system 104 includes a first mix tank 114, a second mix tank 116, a clarification system 118, a sump 120, a plurality of multimedia filters 122, and a pH adjustment tank 124.

In some embodiments, as gel treated flowback water 138 enters the first mix tank 114, a pH probe and controller sense the influent water pH and adds caustic soda 113, such as sodium hydroxide, to a achieve a pH between 9.5 and 11.3. This step converts available alkalinity, usually in the bicarbonate form, to carbonate alkalinity. The pH is maintained under this condition automatically. In some embodiments, contact time in this tank 114 is maintained at greater than 60 minutes. The first mix tank 114 initiates the precipitation of calcium, barium, and strontium as the carbonates and magnesium as the hydroxide based upon the following reactions:

Mg+2(OH) [symbol] Mg(OH)₂ [symbol] _{;}

Ba+CO₃ [symbol] BaCO₃ [symbol] ;

Sr+CO₃ [symbol] SrCO₃ [symbol] ; and

Ca+CO₃ [symbol] CaCO₃ [symbol] .

Stoichemetrically the following relationships exist for these reactions:
1 mg/l Barium requires 0.44 mg/l carbonate;
1 mg/l Calcium requires 1.5 mg/l carbonate;
1 mg/l Strontium requires 0.68 mg/l carbonate; and
1 mg/l Magnesium requires 1.4 mg/l hydroxide.

Any form of hydroxide can be used to perform this reaction including sodium and potassium hydroxides 113 as well as the use of calcium hydroxide (lime) 113. In further embodiments, if the hardness treatment goals are met, no additional steps are required resulting in pH adjusted water 140. In other embodiments, additional carbonates, such as potassium carbonate and/or sodium carbonate 115 or even carbon dioxide gas 117 are added to affect treatment. Samples from this process step are then analyzed to determine the effective hardness removal and result in pH adjusted water 140.

The use of carbon dioxide gas 117 may not require the addition of sodium or potassium carbonates. The gel treated flowback water 138 is exposed to gaseous carbon dioxide 117 while maintaining an elevated pH (9.5-10.5) in the first mix tank 114 through the use of caustic soda 113 (other alkalis such as potassium hydroxide can be substituted for sodium hydroxide) additions based upon automated pH control. The carbonates are formed in situ and then react as described above. The following reactions occur when using carbon dioxide gas 117:

CO₂+H₂O [symbol] H₂CO₃

H₂CO₃+NaOH [symbol] Na₂CO₃ (soda ash)+2H₂O.

The use of carbon dioxide gas 117 may present better material handling options then dry soda ash. The use of gaseous carbon dioxide 117 and liquid caustic soda 113 can be used as a process extender should the soda ash demand of the influent water be greater than the current mechanical capacity to add dry soda ash. In alternative embodiments, the caustic soda 113, sodium carbonate 115, and/or carbon dioxides are added to the gel treated flowback water 138 through a series of multiple mixing tanks. The pH may be monitored in each tank using a pH probe and pH controller. Contact time in subsequent tanks may be maintained at less than 15 minutes.

Next the pH adjusted water 140 from the first mix tank 114 or plurality of first mix tanks 114 flows by gravity (or is pumped) into a second mix tank 116. In the second mix tank 116, a coagulant 119 such, as but not limited to, sodium aluminate, ferric chloride, ferric sulfate, aluminum chloride, aluminum sulfate, polyaluminum chloride or aluminum chlorohydrate may be added to the pH adjusted water 140. In some embodiments, the coagulant 119 is added at an amount between 25 and 250 mg/l by volume to effectively promote floc formation through coagulation. Contact time for this step may be a minimum of 10 minutes. The effluent from the second mixing tank 106 is floc water 142.

The floc water 142 which may contain precipitated forms of calcium, barium and strontium carbonate, iron hydroxide, magnesium hydroxide and possibly barium and strontium sulfates in addition to other hydrous precipitated metals and ions flows into a clarifier 118 or clarification system 118. The clarifier 118 may be an inclined plate clarifier 118 or even a dissolved air flotation clarifier 118, with the overall preferred method being a solids contact clarifier 118. Any means of solids liquid separation can potentially be utilized for this step, including membrane systems. To accelerate solids 146b settling, a polymeric flocculant 121 may be added at an amount between 1 and 5 mg/l. These flocculants can be of the polyacrylamide type and may be anionic or nonionic in charge. The flocculant may be a liquid emulsion or a dry product applied by first diluting said product with water. The flocculant is added into the clarifier 118, which may contain a low speed (2-25 rpm) mixer. The low speed mixer may be applied flow proportionally to the incoming flow rate. Operator adjustment is made manually based upon water characteristics.

The floc water 142 undergoes a solids liquid separation within the clarifier 118, forming a waste sludge 146b which contains 1-10% by weight solids. These solids or sludge 146b are removed from the clarifier bottom, if it's a gravity clarifier 118, and from the clarifier surface, if it's a flotation clarifier 118. The solids 146b can be removed on a continuous or intermittent basis. Removal can be initiated using sludge level equipment located inside the gravity clarifier 118 or through the use of a manually adjusted timer. Clarified water 144 can be decanted from this process and pumped back to the clarifier discharge for further processing.

In some embodiments, the resulting clarified water 144 is discharged from the clarifier 118 by gravity or a pump into a small sump 120 whereby the clarified water 144 is pumped through one or more multimedia filters 122. The one or more filters 122 can contain anthracite, garnet, sand, naturally occurring zeolites or any combination thereof.

The clarified water 144 can be monitored using conventional turbidimetric equipment in the one or more filters 122. Operation of the one or more filters 122 is monitored through pressure differential. In some embodiments, upon exceeding the pressure differential setpoint, a multimedia filter 122 is taken off line and is backwashed using fresh water or treated water for a period of time not to exceed 30 minutes. A previously backwashed filter 122 is simultaneously put online such that no interruption in the treatment of flow occurs. If desired the backwash can be enhanced by using a mixture of water and compressed air, as in an “air scrub” process, whereby the compressed air lifts the media bed and allows trapped solids 146b to pass into the backwash discharge.

More high tech filtration methods may be used such as membrane filtration which is meant to include both polymeric and ceramic membranes. In alternative embodiments, ceramic membranes can be used instead of the clarifier 118. This option can reduce site footprint, although it may increase capital cost. Membrane systems operate much the same way as multimedia filters 122, although backwash may be more frequent but for shorter durations. If desired, backwash can be enhanced by using a mixture of water and compressed air, as in an “air scrub” process, whereby the compressed air scours the membrane surface and allows trapped solids 146b to pass into the backwash discharge.

Both the membrane and multimedia filters 122 result in filtered water 148. The filtered water 148, now containing little or no scale forming minerals and metals, flows from the optional filtration step into a pH adjust tank 124. Carbon dioxide gas 117 from a compressed carbon dioxide source is mixed into the filtered water 148 in the pH adjust tank 124 to facilitate pH neutralization of excess alkalinity. The pH may be reduced to any value from 7.0 to the starting pH of up to 11.3. Mineral acids such as sulfuric or hydrochloric could also be utilized alone or in conjunction with the carbon dioxide to speed the neutralization reaction and/or to minimize the formation of bicarbonates. In some embodiments, the process is monitored and controlled using a pH probe and pH controller which facilitates the addition of carbon dioxide or mineral acids. In some embodiments, the vented carbon dioxide gas 117 from the initial first mixt tank 114 at the water softening system 104 is utilized to assist in pH neutralization at a zero cost balance as this carbon dioxide is that which existed in the frac flowback water when it was received at the treatment site. The pH adjust tank 124 results in finished frac flowback water or gel treated and softened flowback water 150.

The resulting materials from the water treatment system 100 are then appropriately stored, processed and/or transported. For example, the solids 146b from the clarification system 118 may be stored in a first holding tank. Additional gravity settling may occur in the first holding tank. In some embodiments, the thickened inorganic sludge or solids 146b containing the carbonates of calcium, barium and strontium as well as the hydroxides of metals such as iron and magnesium in addition to silicates are disposed of onsite by using this material as fill material when drilling has ceased and site reclamation activities occur. This use is dependent upon state regulations. The solids 146b may also be further dewatered using a recessed chamber filter press, centrifuge or belt filter press or rotary drum vacuum filter. The resulting dewatered cake from any of these processes may achieve final solids content of between 25% and 60%, and/or may be transported offsite for disposal at a state approved landfill.

The finished frac flowback water or the gel treated and softened flowback water 150 is metal free, gel free and scale free (or which exhibits greatly reduced concentrations of metals, gel, and scale forming components depending upon customer needs) is now ready to be recycled or used for backwash operations. In some embodiments, the finished frac flowback water 150 is pumped back into a fresh water pit or into a fresh water storage tank, whichever is available.

The gel removal system 102 offers significant advantages over more conventional treatment options some of which may be based upon standard coagulation and flocculation methods. The presence of gel inhibits conventional treatment and renders most ineffective. The above defined process successfully removes the gel from the frac flowback water in a unique and highly repeatable method. The process has been demonstrated on flowback waters that have originated from several well sites each of which utilizes different frac chemistry as supplied by companies such as Halliburton and Schlumberger. The gel removal system 102 creates a separable solid 111 which has unique properties and physical characteristics unlike any other treatment process evaluated. The solids 111 produced using the gel removal system 102 are cohesive in nature and demonstrate exceptional sheer resistance during physical separation. The solids 111 generated by the gel removal system 102 dewater quickly and easily allowing multiple dewatering technologies to be applicable.

This gel removal system 102 provides a solution to the treatment of flowback water containing gel 130 as well as a feasible alternative to scale removal. We have recorded COD reductions of greater than 50%, 60%, 70%, and 75% of gel being removed as illustrated under EXAMPLE 1 below. Accordingly, the gel removal system 102 as disclosed herein removes 50% or more of the gel, such as guar, from the frac flowback water resulting in a 50% total gel percent removal. In other embodiments, the gel removal system 102 as disclosed herein removes 60% or more of the gel from the frac flowback water resulting in a 60% total gel percent removal. In other embodiments, the gel removal system 102 as disclosed herein removes 70% to 75% or more of the gel from the frac flowback water resulting in a 70% to 75% total gel percent removal. In comparison, typical previously utilized systems report 30-40% removal. The removal of the gel allows conventional chemical precipitation softening to be used as well as the alternate carbon dioxide method described herein.

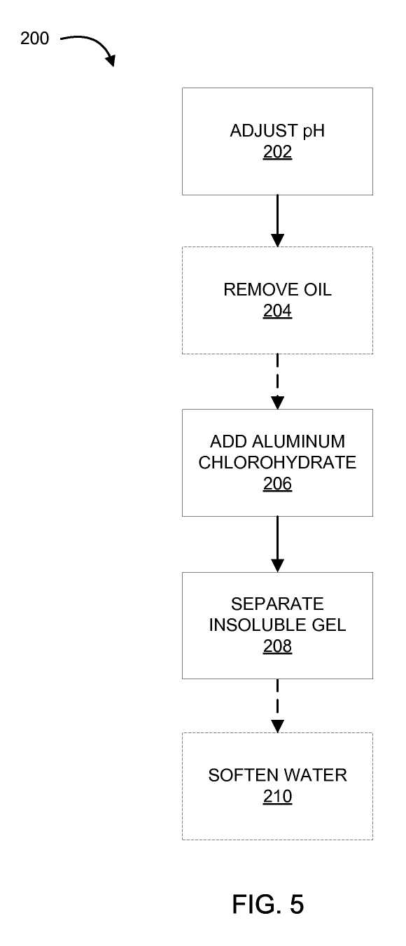

FIG. 5 illustrates an embodiment of a method 200 for treating contaminated water. During method 200 gel, such as guar, is removed from the contaminated water. Method 200 has documented COD reductions of greater than 50%, 60%, 70%, and 75% of gel being removed as illustrated under EXAMPLE 1 below. Accordingly, method 200 removes 50% or more of the gel, such as guar, from flowback water.

As illustrated, method 200 includes an adjusting pH operation 202. During the adjusting pH operation 202, acid is added to the flowback water to adjust the pH to 5 or less to form acidified water. In some embodiments, the pH is adjusted to about 4.0 to 5.0. In other embodiments, the pH is adjusted to about 4.5 to 5.0. In yet another embodiment, the pH is adjusted to about 5.5 or less. In some embodiments, the acid is hydrochloric acid. In other embodiments, the acid is sulfuric acid. In some embodiments, the acid is added to flowback water in a tank, such as a surge tank or a mixing tank. In some embodiments, an oxidizer is further added to the frac flowback water during the adjusting pH operation 202. The oxidizer may be any form of hydroxide, such as sodium hydroxide, calcium hydroxide, and/or potassium hydroxide.

The addition of acid effectively removes soluble carbon dioxide and bicarbonates through conversion to carbon dioxide gas which is stripped through the action of mixing. In some embodiments, the escaping carbon dioxide gas from the surge tank is captured for use later. In some embodiments, the addition of acid is controlled automatically using a pH controller and pH probe. For example, the addition of acid may result in the following equation:

HCO₃+HCl [symbol] CO₂ [symbol] +H₂O+Cl.

Other options for those skilled in the trade for air stripping carbon dioxide would be packed columns, tray towers, spray systems and membranes systems. Membrane systems may be prone to malfunction due to gel contained in some of the flowback water. These systems could follow the surge tank and would allow the minimization of surge tank volume to a volume large enough to accomplish pH adjustment efficiently.

In some embodiments, method 200 further includes a removing oil operation 204. During the removing oil operation 204, oil is separated from the acidified water. In some embodiments, the oil is removed from the acidified water by utilizing a coalescing separator. The oil may be recovered for resale. In other embodiments, the removing oil operation 204 utilizes a unique oil/water separator which combines the solids handling capability of an inclined plate separator along with the coalescing ability of a media with a high surface area, such as HD Q-PAC. In some embodiments, the oil removal system 101 results in recovery of up to 99% of oil droplets greater than 20 microns. Further, method 200 includes an adding aluminum chlorohydrate operation 206.

During adding operation 206, aluminum chlorohydrate is added to the acidified water to precipitate insoluble gel out of the acidified water. As discussed above the acidified water may have had oil contained within the acidified water removed by the optional removing oil operation 204. In some embodiments, the adding operation 206 is performed by a coagulation tank. The rate of the addition of the aluminum chlorohydrate may be determined by applicable jar tests or by active monitoring. The addition of the chlorohydrate causes an immediate and rapid separation of the gel, such as guar. The reaction can be followed visually and the newly formed gel is insoluble in the acidified water. In addition, the gel, with a specific gravity lower than water floats to the surface at a rapid rate.

Next, method 200 includes a separating insoluble gel operation 208. During the separating operation 208, the insoluble gel is separated from the acidified water. The acidified water containing the insoluble gel must remain at a pH of 5 or less as any attempt to raise the pH of the fluid containing the gel allows the gel to resolubilize. Accordingly, separation of the insoluble gel must be accomplished under acidic conditions. Previously utilized gel separation methods were always performed at or around a neutral pH. Accordingly, it was unexpected for the aluminum chlorohydrate to work utilizing an acidic pH.

In some embodiments, to take advantage of the buoyant characteristics of the insoluble gel, the separation methods are dissolved air floatation (DAF), induced air floatation or dissolved gas floatation. In this embodiment, the insoluble gel accumulates on the surface of the flotation area of the clarifier or separator and is removed by the clarifiers sludge removal mechanism. The solids produced are rubber-like in consistency and dewater readily. The solids can be dewatered through any means conventionally used by those skilled in the art. In some embodiments, a plurality of separators are utilized during the separating operation 208. The separating operation 208 results in a low turbidity, low total suspended solids effluent (i.e. flowback fluid containing little to no soluble gel). The primary remaining constituents of concern are now scale forming ions as described earlier in this review.

In some embodiments, method 200 further includes a softening water operation 210. During the softening water operation 210, the flowback fluid containing little to no soluble gel or the gel treated flowback water is softened by any known suitable method or system for softening gel treated flowback water. For example, the water softening operation 210 may utilize the water softening system 104 disclosed above and illustrated in FIGS. 1 and 4.

### EXAMPLES

### Example 1

The gel removal system was tested for several months in the DJ Basin located north of Denver, Colo. Over 1800 barrels of flowback waters from local fracing operations were treated on a pilot scale and an additional 1800 barrels of blended flowback and produced water were also treated. This gel removal system was tested over a nine month period. The gel removal system exhibited the documented reduction in COD as shown in Table 1 below:

TABLE 1
Documented COD Removal by Gel Removal System

| | | Finished | DAF COD | Total COD |
|---|---|---|---|---|
| Influent COD | DAF COD | Water | Percent | Percent |
| (mg/L) | (mg/L) | COD (mg/L) | Removal (%) | Removal (%) |
| 7590 | 3030 | 2610 | 60 | 66 |
| 5790 | 3560 | 1490 | 39 | 74 |
| 7960 | 4240 | 1910 | 47 | 76 |

In addition, the presence of calcium, magnesium, barium and strontium in the DJ Basin of Colorado varied based on whether the water was flowback or produced water. Produced water had the highest amount of hardness ions. Measured values of 1600 mg/l of calcium carbonate were documented in the produced water. The water treatment system as disclosed herein consistently reduced the hardness of the treated water to less than 80 mg/l and more typically 50 mg/l as calcium carbonate. Produced water hardness was generally found to be at 200 mg/l or less as calcium carbonate and was reduced to below the 50 mg/l hardness level on a consistent basis.

### Example 2

The data listed below in Table 2 represents the mathematical average of laboratory analysis conducted by an independent 3^{rd} party analytical lab located in Thornton, Colo. on the frac flowback water from the DJ Basin located north of Denver, Colo. over several months treated by the water treatment system disclosed herein.

TABLE 2
Water Treatment Analysis Performed by 3^{rd} Party Laboratory

| | | | | Average |
|---|---|---|---|---|
| | | | Post | Percent |
| | | Pretreatment | Treatment | Removal |
| | Analyte | Average | Average | (%) |
| Physical | pH | 7.20 | 8.68 | |
| | Specific Gravity | 1.00 | 1.04 | |
| | Conductivity | 29,400 | 30,000 | |
| | (umhos/cm) | | | |
| | TDS (mg/L) | 15,600 | 14,600 | 6.4 |
| | TOC (mg/L) | 436 | 323 | 26.0 |
| Inorganic | Barium (mg/L) | 5.42 | 0.56 | 89.7 |
| | Calcium (mg/L) | 206 | 18 | 91.3 |
| | Iron (mg/L) | 42 | 0.57 | 98.6 |
| | Magnesium (mg/L) | 30 | 13 | 56.2 |
| | Potassium (mg/L) | 478 | 498 | 0.0* |
| | Sodium (mg/L) | 5,080 | 5,480 | 0.0* |
| | Arsenic (mg/L) | 0.04 | 0.04 | 5.1 |
| | Cadmium (mg/L) | 0.04 | 0.00 | 100.0 |
| | Chromium (mg/L) | 0.03 | 0.02 | 28.2 |
| | Lead (mg/L) | 0.00 | 0.00 | 100.0 |
| | Manganese (mg/L) | 0.58 | 0.03 | 95.0 |
| | Selenium (mg/L) | 0.30 | 0.27 | 11.1 |
| | Chloride (mg/L) | 8,168 | 8,420 | 0.0* |
| | Bromide (mg/L) | 64 | 65 | 0.0* |
| | Fluoride (mg/L) | 11 | 9 | 12.6 |
| | Nitrate as N (mg/L) | 1.92 | 0.78 | 59.4 |
| | Nitrite as N (mg/L) | 32 | 0.85 | 97.4 |
| | Sulfate (mg/L) | 125 | 168 | 0.0* |
| | Bicarbonate (mg/L) | 468 | 254 | 45.7 |
| | Carbonate (mg/L) | 0 | 122 | 0.0* |
| Organic | DRO (mg/L) | 472 | 7 | 98.6 |
| | GRO (mg/L) | 92 | 15 | 83.9 |
| | 1,2,4- | 1.32 | 0.16 | 87.7 |
| | Trimethylbenzene | | | |
| | (mg/L) | | | |
| | 1,3,5- | 0.66 | 0.06 | 91.5 |
| | Trimethylbenzene | | | |
| | (mg/L) | | | |
| | 2-Butanone (mg/L) | 0.20 | 0.03 | 0.0* |
| | 2-Chlorotoluene | 0.04 | 0.00 | 90.7 |
| | (mg/L) | | | |
| | 2-Hexanone (mg/L) | 0.01 | 0.00 | 100.0 |
| | 4-Methyl-2-Pentanone | 0.16 | 0.14 | 13.9 |
| | (mg/L) | | | |
| | Carbon Disulfide | 0.00 | 0.02 | 0.0* |
| | (mg/L) | | | |
| | Ethylbenzene (mg/L) | 0.46 | 0.13 | 71.6 |
| | Isopropylbenzene | 0.09 | 0.01 | 87.4 |
| | (mg/L) | | | |
| | Naphthalene (mg/L) | 0.26 | 0.60 | 77.2 |
| | n-Butybenzene (mg/L) | 0.07 | 0.00 | 94.4 |
| | n-Propylbenzene | 0.17 | 0.01 | 92.0 |
| | (mg/L) | | | |
| | O-Xylene (mg/L) | 1.20 | 0.39 | 67.3 |
| | sec-Butylbenzene | 0.03 | 0.00 | 95.3 |
| | (mg/L) | | | |
| | Acetone (mg/L) | 5.40 | 4.38 | 18.9 |
| | Benzene (mg/L) | 3.40 | 1.80 | 47.1 |
| | m&p Xylenes (mg/L) | 4.02 | 1.06 | 73.6 |
| | Toluene (mg/L) | 6/06 | 2.78 | 54.1 |
| Bio | E. Coli | 374,250 | 0 | 100.0 |
| | Total Coliform | 8,330,000 | 0 | 100.0 |

*Some data points actually increased through the processing of this water and are indicated by a 0.00 in the Average Percent Removal Column. These are typically elements such as sodium and chlorides which are added during the chemical adjustment steps in the form of sodium hydroxide and hydrochloric acid.

As Table 2 demonstrates, the water treatment system as described herein was successful in reducing a wide variety of contaminants commonly found in produced and flowback waters located in the DJ Basin of Colorado. For example, over 90% of calcium, iron, cadmium, lead, manganese, nitrite as N, DRO, 1,3,5-trimethylbenzene, 2-Chlorotoluene, 2-Hexanone, n-butylbenzene, n-propylvbenzene, sec-butylbenzene, E.Coli, and total coliform was removed from the frac flowback water treated with the disclosed water treatment system.

Numerous other changes may be made which will readily suggest themselves to those skilled in the art and which are encompassed in the spirit of the disclosure and as defined in the appended claims. While various embodiments have been described for purposes of this disclosure, various changes and modifications may be made which are well within the scope of the present invention. Numerous other changes may be made which will readily suggest themselves to those skilled in the art and which are encompassed in the spirit of the disclosure and as defined in the claims.

What is claimed is:

1. A water treatment system, the system comprising:
an oil removing system, the oil removing system adds acid until a pH of about 5 or less is reached and removes oil from gel containing flowback water to form oil treated acidified flowback water;
a gel removing system, the gel removing system adds aluminum chlorohydrate to the oil treated acidified flowback water to form gel treated flowback water; and
a water softening system, the water softening system softens the gel treated flowback water to form softened treated flowback water.

2. The system of claim 1, wherein the gel is guar.

3. The system of claim 1, wherein the oil removing system acidifies the gel containing flowback by utilizing hydrochloric acid.

4. The system of claim 1, wherein the oil removing system removes at least 85% of oil droplets greater than 20 microns from the gel containing flowback water.

5. The system of claim 1, wherein the gel removing system utilizes a dissolved air flotation separator to remove the gel.

6. The system of claim 1, wherein the gel removing system results in a total gel percent removal of at least 50%.

7. The system of claim 1 wherein the pH is about 4 to 5.

8. The system of claim 1, wherein the gel removing system results in a total COD percent removal of at least 50%.

9. The system of claim 1, wherein the gel removing system results in a total COD percent removal of at least 60%.

10. The system of claim 1, wherein the softened treated flowback water contains less than 80 mg/l of calcium carbonate.

11. A method for removing gel from flowback water, the method comprising:
adjusting a pH of flowback water to about 5 or less to form acidified water;
adding aluminum chlorohydrate to the acidified water causing gel to precipitate out of the acidified water; and
separating the gel from the acidified water to form gel treated flowback water.

12. The method of claim 11, wherein the gel is guar.

13. The method of claim 11, wherein the gel is separated from the acidified water by utilizing dissolved air flotation.

14. The method of claim 11, wherein the pH of the flowback water is adjusted by adding hydrochloric acid.

15. The method of claim 11, further comprising:
removing oil from the acidified water before adding the aluminum chlorohydrate.

16. The method of claim 11, wherein the step of adjusting the pH of the flowback water adjusts the pH to about 4 to 5.

17. The method of claim 11, wherein a total COD percent removal is at least 50%.

18. The method of claim 11, wherein a total gel percent removal is at least 50%.

19. The method of claim 11, further comprising:
softening the gel treated flowback water.

20. The method of claim 11, wherein the step of adjusting the pH of the flowback water further includes:
adding an oxidizer, and
wherein the oxidizer is at least one of hydrogen peroxide, ozone, sodium hypochlorite, chlorine dioxide, persulfates sodium permanganate, and potassium permanganate.
